(19) United States
(12) Patent Application Publication
(10) Pub. No.: US 2012/0269600 A1
(43) Pub. Date: Oct. 25, 2012

(54) PRINTING APPARATUS, METHOD FOR CONTROLLING PRINTING APPARATUS AND STORAGE MEDIUM

(75) Inventor: Yasuhiro Kozuka, Tokyo (JP)

(73) Assignee: CANON KABUSHIKI KAISHA, Tokyo (JP)

(21) Appl. No.: 13/447,038

(22) Filed: Apr. 13, 2012

(30) Foreign Application Priority Data
Apr. 19, 2011 (JP) 2011-093274

(51) Int. Cl. B42B 5/00

(52) U.S. Cl. 412/33

(57) ABSTRACT

A printing apparatus includes a post-processing control unit, an adding control unit, and a control unit. The post-processing control unit performs control to perform binding processing for binding a print product. The adding control unit performs control to add, to the print product, a sheet representing an area where printing has been interrupted due to occurrence of an interruption factor. The control unit performs control not to perform the binding processing for the print product to which the sheet has been added by the adding control unit.

### BACKGROUND OF THE INVENTION

1. Field of the Invention

The present invention relates to a printing apparatus, a method for controlling the printing apparatus, and a storage medium.

2. Description of the Related Art

A printing system in which a finisher apparatus for performing post-processing is connected to a printing apparatus, to output a print product has been put into practical use. Further, the print-on-demand (POD) business using such a printing system also exists. In such POD business, the quality of the output print product must be inspected, and a person in charge of inspection visually inspects the print product. However, in a normal printing apparatus, sheet contamination may occur particularly due to toner scattering immediately after recovery of a jam.

Therefore, there is a desire to output a color sheet or a tab sheet to an area where recovery has occurred as an interleaf so that a sheet output spot immediately after the recovery, can be easily determined even after the job. For example, Japanese Patent Application Laid-Open No. 2008-262103 discusses a means for inserting an interleaf as a mark into an area where printing is to be resumed.

However, a recent printing apparatus includes outputting functions in various output formats. If processing is performed as it is by setting and retaining a staple output function or other bookbinding functions, for example, a print product is bound with an interleaf nipped therein, which is not originally included in the print product. In order to obtain a desired print product, therefore, a user is required to remove a staple from the print product, and bind the print product again after the interleaf is removed, which complicates a printing operation.

### SUMMARY OF THE INVENTION

According to an aspect of the present invention, a printing apparatus includes a post-processing control unit configured to perform control to perform binding processing for binding a print product, an adding control unit configured to perform control to add, to the print product, a sheet representing an area where printing has been interrupted due to occurrence of an interruption factor, and a control unit configured to perform control not to perform the binding processing for the print product to which the sheet has been added by the adding control unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of a system configuration of a printing system that provides a printing apparatus.

FIG. 2 is a cross-sectional view illustrating an internal configuration of a printer unit in an image forming apparatus.

FIG. 3 is a cross-sectional view illustrating the internal configuration of the printer unit in the image forming apparatus illustrated in FIG. 1.

FIG. 4 is a cross-sectional view illustrating an example of a configuration of a finisher unit illustrated in FIG. 1.

FIG. 5 is a block diagram illustrating in outline a connected state of a control system in the finisher unit.

FIG. 6A is a flowchart illustrating a method for controlling the printing apparatus.

FIG. 6B is a flowchart illustrating a method for controlling the printing apparatus.

FIG. 6C is a flowchart illustrating a method for controlling the printing apparatus.

FIG. 7 illustrates an example of a UI displayed on a display unit in a client PC.

FIG. 8 is a flowchart illustrating a method for controlling the printing apparatus.

FIG. 9 illustrates an example of a user interface displayed on an operation unit.

FIG. 10 is a flowchart illustrating a method for controlling the printing apparatus.

### DESCRIPTION OF THE EMBODIMENTS

Various exemplary embodiments, features, and aspects of the invention will be described in detail below with reference to the drawings.

### <Description of System Configuration>

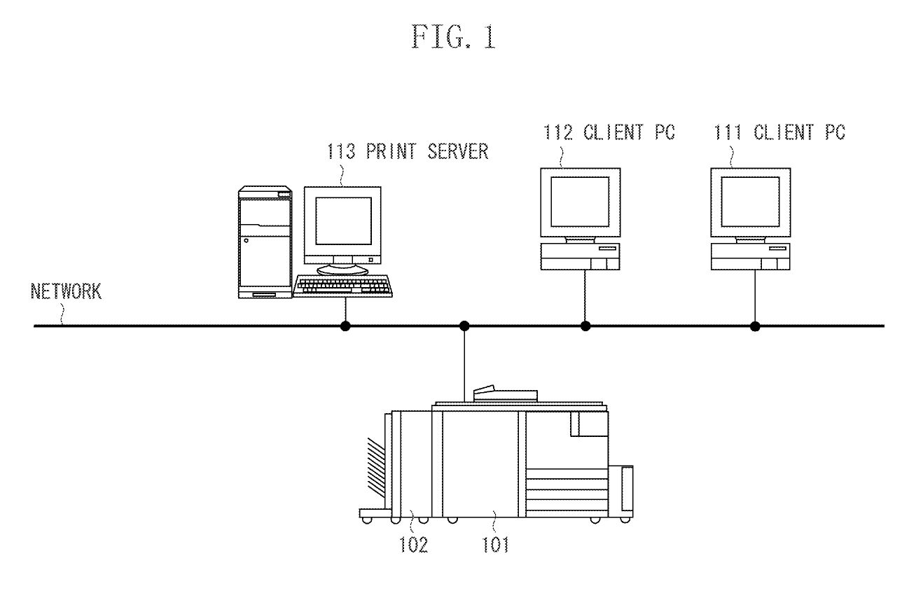

FIG. 1 illustrates an example of a system configuration of a printing system that provides a printing apparatus according to a first exemplary embodiment. In the present exemplary embodiment, an image forming apparatus equipped with multi-functions, to which a post-processing apparatus can be connected to perform post-processing such as stapling processing or case binding processing on sheets, will be described as an example of the printing apparatus. Therefore, the present invention is applicable to both a post-processing apparatus for performing only the either type of post-processing and a post-processing apparatus capable of performing each type of post-processing.

A post-processing apparatus for performing post-processing to collectively output a plurality of sheets printed according to a set post-processing mode (a mode of performing the stapling processing or the case binding processing) as one print product can be connected to the printing apparatus. More specifically, a finisher unit 102 can perform the post-processing (the stapling processing or the case binding processing) according to the post-processing mode (the mode of performing the stapling processing or the case binding processing).

In FIG. 1, an image forming apparatus 101 processes various types of input data, and performs output for printing. The finisher unit 102 sorts, staples, and folds an output sheet printed by the image forming apparatus 101 depending on a desired output format. The image forming apparatus 101 is connected to an external print server 113 and client personal computers (PCs) 111 and 112 via a network.

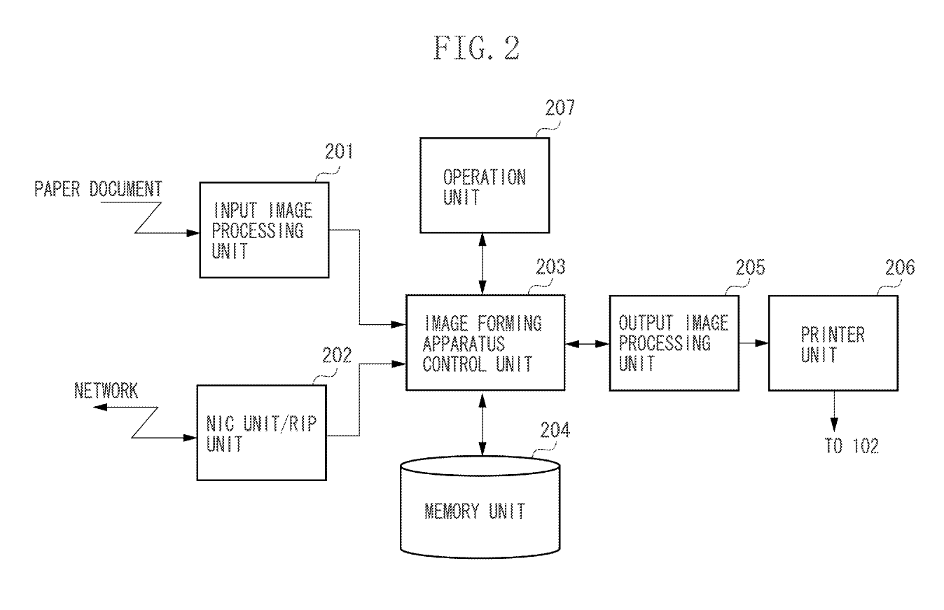

FIG. 2 is a block diagram illustrating a configuration of a printer control unit in the image forming apparatus 101 illustrated in FIG. 1.

In FIG. 2, an input image processing unit 201 reads a paper document or the like using an image reading device such as a scanner, and subjects image data obtained by the reading device to image processing.

A network interface control (NIC) unit/raster image processor (RIP) unit 202 transfers image data (mainly page description language (PDL) data) input using the network to an RIP unit in the NIC unit/RIP unit 202, or sends image data and apparatus information in the image forming apparatus 101 to the outside via the network. The RIP unit decrypts the input PDL data, and performs RIP rasterization.

The input image data is then sent to an image forming apparatus control unit 203. The image forming apparatus control unit 203 functions to control data to be input and data to be output.

The image data input to the image forming apparatus control unit 203 is once stored in a memory unit 204. The image data stored in the memory unit 204 is temporarily stored, or is called, as needed.

An output image processing unit 205 subjects the image data to image processing for printing, and sends the processed image data to a printer unit 206. The printer unit 206 feeds sheets, and sequentially prints the image data generated by the output image processing unit 205 on the sheets. The sheet printed out is sent out to the finisher unit 102. Further, an operation unit 207 selects various operation flows and functions as described above, and issues an instruction to perform an operation, and is capable of displaying various user interface (UI) screens.

The image forming apparatus control unit 203 performs processing for determining whether a state of the printer unit 206 transits from a state where print processing is interrupted to a state where the print processing can be resumed again.

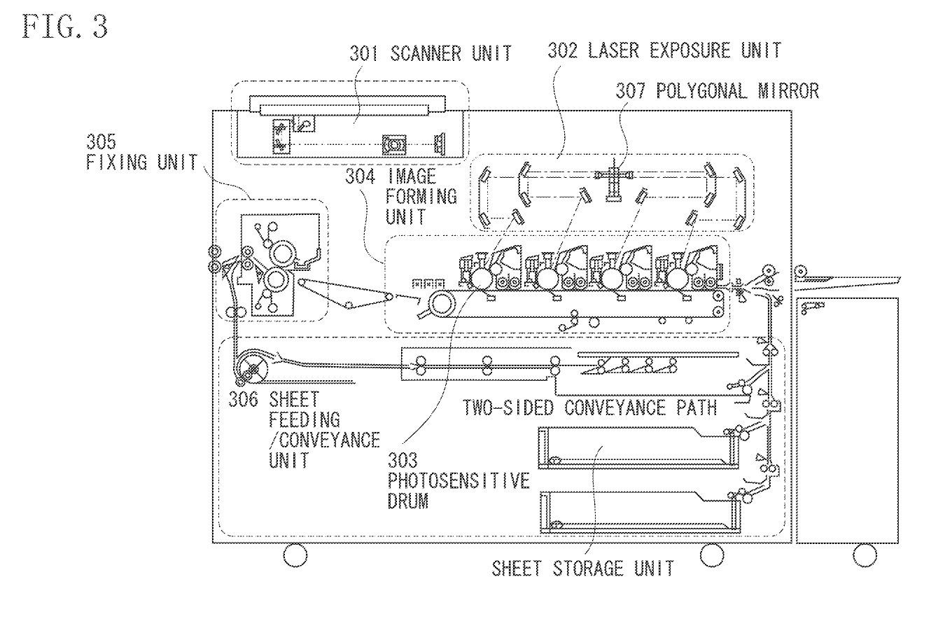

FIG. 3 is a cross-sectional view illustrating an internal configuration of the printer unit 206 in the image forming apparatus 101 illustrated in FIG. 1.

In FIG. 3, the image forming apparatus 101 includes a scanner unit 301, a laser exposure unit 302, a photosensitive drum 303, an image forming unit 304, a fixing unit 305, a sheet feeding/conveyance unit 306, and the printer control unit described in FIG. 2 for controlling these units. The scanner unit 301 illuminates a document placed on a document plate, to optically read a document image, and converts the document image into an electric signal, to generate image data.

The laser exposure unit 302 makes a light beam such as a laser beam, which has been modulated according to the image data, incident on a rotating polygonal mirror 307. The polygonal mirror 307 rotates at a constant angular speed, and the laser exposure unit 302 irradiates the photosensitive drum 303 with the reflected laser beam as scanning light.

The image forming unit 304 performs a series of electrophotographic processes. More specifically, the image forming unit 304 drives and rotates each of photosensitive drums 303 provided for each color of developers (toners), charges the photosensitive drum 303 for each of the colors using a charger, and develops a latent image formed on the photosensitive drum 303 for each of the colors by the laser exposure unit 302 using the developer for the color. Then, the image forming unit 304 transfers a toner image of each color onto a sheet, and recovers the minute toner remaining on each of the photosensitive drums 303 without being transferred. In the present exemplary embodiment, the image forming unit 304 includes four series of development units (development stations) in a parallel manner.

The four development units are serially arranged in order of cyan (C), magenta (M), yellow (Y), and black (K). The development units sequentially perform magenta, yellow, and black image forming operations after predetermined periods of time have elapsed after the cyan development unit performed a cyan image forming operation.

Under this timing control, a full-color toner image having no color misregistration is transferred onto the sheet. While it is assumed that the present exemplary embodiment is a color printer, the present invention is not limited to this. Only the black development unit is loaded in case of a monochrome printer.

The fixing unit 305 is configured of a combination of rollers and belts, and includes a heat source such as a halogen heater. The fixing unit 305 dissolves and fixes the toner on the sheet, onto which the toner image in each color has been transferred by the image forming unit 304, by applying heat and pressure. The sheet feeding/conveyance unit 306 includes one or more sheet storage units represented by sheet cassettes and paper decks. The printer unit 206 separates one of sheets stored in the sheet storage unit according to an instruction from the printer control unit provided in the printer unit 206, and conveys the sheet to the image forming unit 304 and the fixing unit 305. While the sheet is conveyed, the toner images in the respective colors are transferred onto the sheet by the above-mentioned development units so that a full-color toner image is finally formed thereon.

If an image is formed on both surfaces of the sheet, the sheet which has passed through the fixing unit 305 is controlled to pass through a conveyance path for conveying the sheet to the image forming unit 304 again. The printer control unit communicates with the image forming apparatus control unit 203 for controlling the entire image forming apparatus 101, to perform control according to an instruction from the image forming apparatus control unit 203. In this case, while the printer control unit causes the entire apparatus to operate smoothly and in harmony with one another, the printer control unit issues instructions to manage states of the scanner unit 301, the laser exposure unit 302, the image forming unit 304, the fixing unit 305, and the sheet feeding/conveyance unit 306 to.

### [Example of Configuration of Finisher Unit]

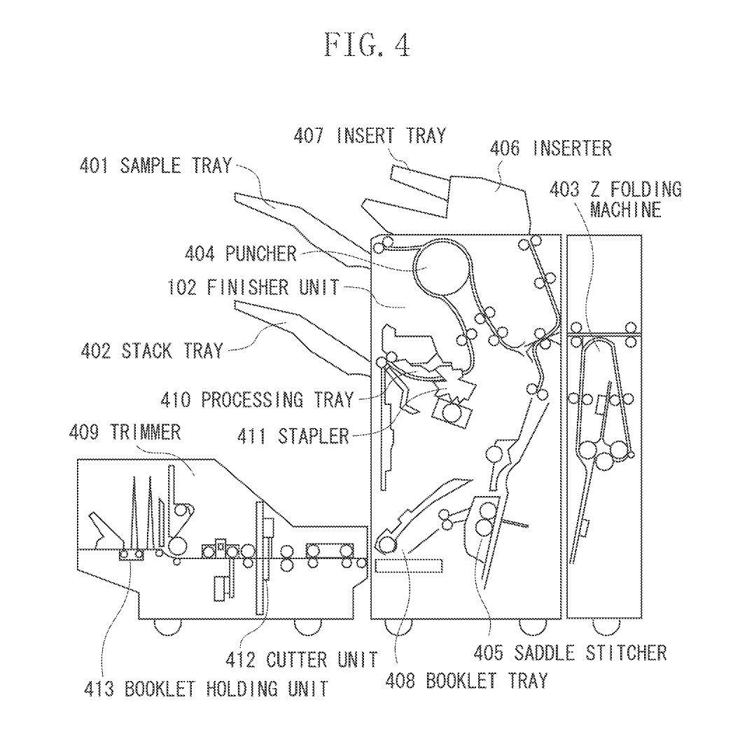

FIG. 4 is a cross-sectional view illustrating an example of a configuration of the finisher unit 102 illustrated in FIG. 1. In FIG. 4, a sheet discharged from the image forming apparatus 101 enters the finisher unit 102. The finisher unit 102 includes a sample tray 401 and a stack tray 402 as a discharge tray. The sample tray 401 and the stack tray 402 are switched when discharging the sheets depending on the type of job and the number of sheets to be discharged.

Further, if a staple mode is set for a job to be output, control is performed to discharge sheets onto the stack tray 402. In this case, the sheets are sequentially stored in a processing tray 410 inside the finisher unit 102 for each job before being discharged onto the stack tray 402. A stapler 411 binds the sheets on the processing tray 410 into a sheet bundle. Then, the sheet bundle is discharged onto the stack tray 402.

A Z folding machine 403 for folding a sheet in a Z shape and a puncher 404 for punching two (or three) holes for a file are provided up to the sample tray 401 and the stack tray 402. The Z folding machine 403 and the puncher 404 perform respective processes depending on the type of job.

If a user sets a post-processing mode such as a Z folding mode via an operation unit as the post-processing related setting for a job to be output, for example, the Z folding machine 403 performs folding processing for a sheet in the job.

Control is performed to discharge the sheet onto the stack tray 402 and the sample tray 401 serving as a discharge tray after passing the sheet through the Z folding machine 403. Alternatively, if the user makes a punching setting via the operation unit 207 as the post-processing related setting for the job to be output, for example, the puncher 404 performs punching for the sheet in the job. Then, control is performed to discharge the sheet onto the stack tray 402 and the sample tray 401 serving as a discharge tray after passing the sheet through the Z folding machine 403.

Further, a saddle stitcher 405 performs processing for generating a booklet such as a brochure (bookbinding processing) by binding the sheet at two portions of its center, and then causing the roller to nip the center of the sheet with the roller, to fold the sheet in half.

The sheet, which has been book-bound by the saddle stitcher 405, is discharged onto a booklet tray 408. It is determined whether an operation for post-processing such as bookbinding processing is to be performed by the saddle stitcher 405 based on the post-processing mode setting made by the user for the job to be output, as described above.

An inserter 406 feeds an interleaf (a sheet) set in an insert tray 407 to either one of the stack tray 402 and the sample tray 401 without passing the interleaf through the printer unit 206. Thus, the interleaf set in the inserter 406 can be inserted between sheets (sheets printed by the printer unit 206) fed into the finisher unit 102.

The user sets the sheets in a face-up state on the insert tray 407 in the inserter 406. A pick-up roller feeds the sheets in order from the uppermost sheet. Therefore, the interleaf from the inserter 406 is conveyed to the stack tray 402 or the sample tray 40 and directly discharged in a face-down state. The sheets are fed into the puncher 404 once and switched back when fed into the saddle stitcher 405 so that directions of their faces are matched.

It is determined whether an operation for post-processing such as interleaf insertion processing by the inserter 406 is to be performed based on the post-processing mode setting made by the user for the job to be output, as described above.

A trimmer (a paper cutting machine) 409 will be described below.

A booklet (a saddle stitched booklet), which has been generated by the saddle stitcher 405 and output therefrom, enters the trimmer 409. In the case, the roller feeds the output booklet by a predetermined length, and the cutter unit 412 cuts the output booklet by the predetermined length so that their edges, which are uneven for a plurality of pages in the booklet, properly line up. The booklet is stored in a booklet holding unit 413. It is determined whether an operation for post-processing such as cutting processing by the trimmer 409 is to be performed based on the post-processing mode setting made by the user for the job to be output, as described above.

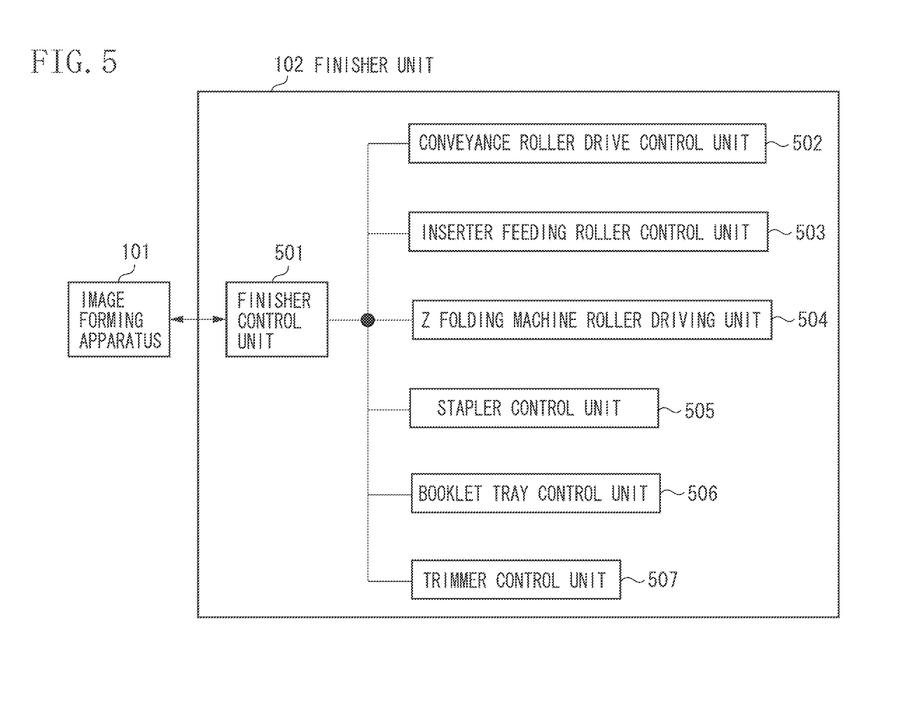

FIG. 5 is a block diagram illustrating a schematic connected state of a control system of the finisher unit 102 illustrated in FIG. 1.

The image forming apparatus control unit 203 in the image forming apparatus 101 and a finisher control unit 501 in the finisher unit 102 are connected to each other via a dedicated communication line. The finisher control unit 501 receives finisher setting information corresponding to a job from the image forming apparatus 101, and communicates with each of control units, described below, for controlling respective functions in the finisher unit 102 based on the received finisher setting information.

A conveyance roller driving control unit 502 guides sheets to various types of finishing units based on job control information sent from the finisher control unit 501. If there is a desire to perform staple output, for example, the finisher control unit 501 communicates with a stapler control unit 505, to receive status information of the stapler control unit 505 and send the job control information to the stapler control unit 505, and the stapler control unit 505 performs a stapling operation according to a content of the job.

Control is also performed according to the job control information from the finisher control unit 501 with respect to an inserter sheet feeding roller control unit 503, a Z folding roller driving unit 504, a booklet tray control unit 506, and a trimmer control unit 507. Thus, an output product, which has been subjected to desired post-processing, is output.

### [Processing for Inserting Interleaf During Recovery]

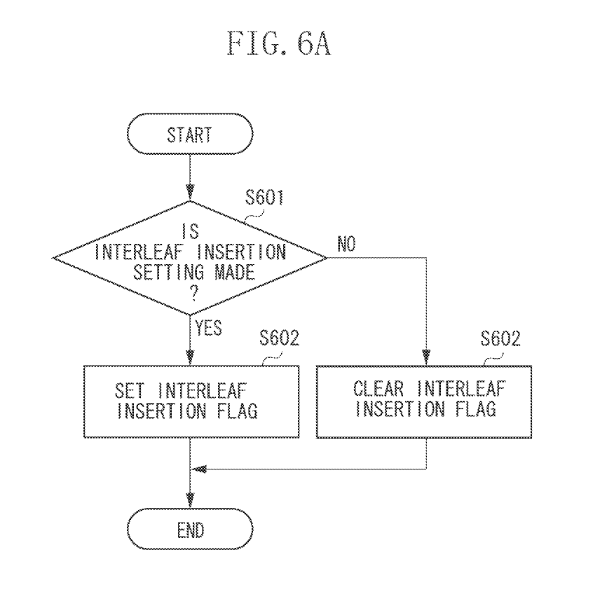

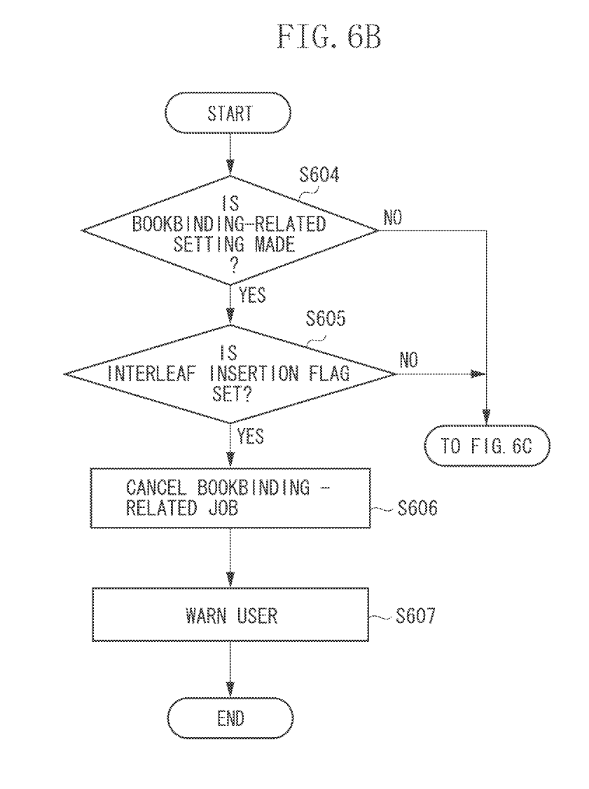

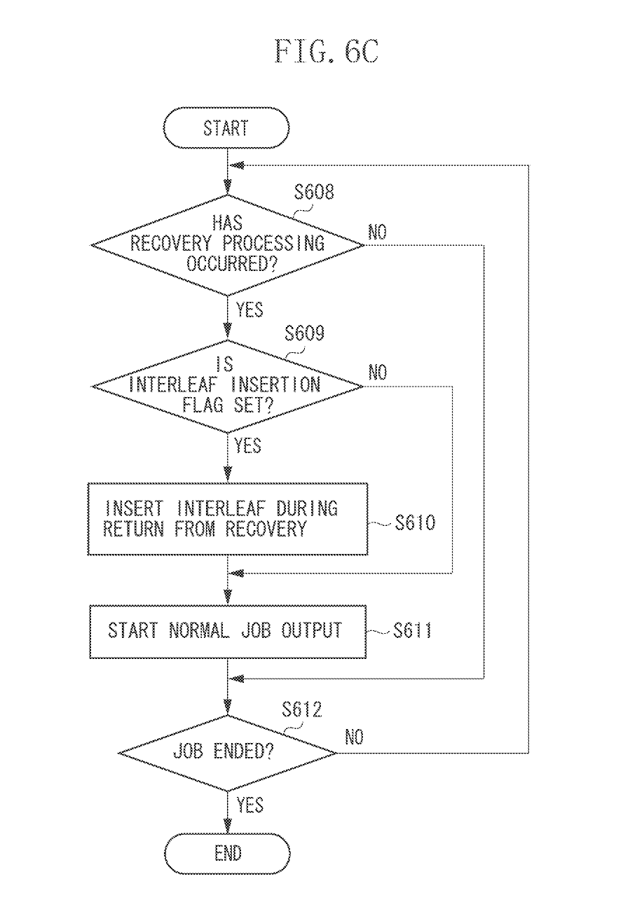

FIG. 6A is a flowchart illustrating a method for controlling the printing apparatus according to the present exemplary embodiment. This example is an example of processing performed when an interleaf such as a color sheet or a tab sheet is inserted during recovery. The interleaf is inserted during recovery to make a printed state on an output sheet after the recovery easily determinable later. Each of steps is implemented when a central processing unit (CPU) provided in the image forming apparatus control unit 203 loads a control program into a random access memory (RAM) from a read-only memory (ROM) or another storage device, which is not illustrated, and executes the control program.

The processing illustrated in FIG. 6A is performed when a setting of a job is received from the user before an instruction to execute the job is received via the operation unit 207.

In step S601, the image forming apparatus control unit 203 determines whether an interleaf insertion setting using the interleaf set in the inserter 406 is made using the operation unit 207, for example. If the image forming apparatus control unit 203 determines that the interleaf insertion setting has been made (YES in step S601), the processing proceeds to step S602. In step S602, the image forming apparatus control unit 203 sets an interleaf insertion flag in the memory unit 204 in the image forming apparatus 101 (sets the interleaf insertion flag to one), and the processing ends.

On the other hand, if the image forming apparatus control unit 203 determines that the interleaf insertion setting is not made (NO in step S601), the processing ends by clearing the interleaf insertion flag (setting the interleaf insertion flag to zero).

Thus, “1” and “0” are stored and managed as an interleaf insertion flag for determining whether processing for inserting an interleaf is performed during recovery on a memory of the image forming apparatus control unit 203.

While an example in which the user uses the operation unit 207 to set the interleaf has been described in the present exemplary embodiment, the interleaf may be set from the client PC via the network. Alternatively, the interleaf may be settable from either one or both of the operation unit 207 and the client PC.

FIG. 6B is a flowchart illustrating a method for controlling the printing apparatus according to the present exemplary embodiment. This example is an example of processing performed when a job is input. Each of steps is implemented when the CPU provided in the image forming apparatus control unit 203 loads a control program into the RAM from a ROM or another storage device (not illustrated) and executes the control program.

The processing illustrated in FIG. 6B is performed in response to reception of an instruction to execute a job via the operation unit 207.

In step S604, the image forming apparatus control unit 203 determines whether a bookbinding-related setting is made using the operation unit 207, for example. If the image forming apparatus control unit 203 determines that the bookbinding-related setting has been made (YES in step S604), the processing proceeds to step S605. In step S605, the image forming apparatus control unit 203 further determines whether the interleaf insertion flag is set in the processing illustrated in FIG. 6A. If the image forming apparatus control unit 203 determines that the interleaf insertion flag has been set (YES in step S605), the processing proceeds to step S606. In step S606, the image forming apparatus control unit 203 stops a bookbinding-related job set by the operation unit 207 without executing the bookbinding-related job. In step S607, the image forming apparatus control unit 203 displays a warning that the bookbinding-related setting is inhibited on the operation unit 207 if the interleaf insertion setting is made on a user screen.

On the other hand, if the image forming apparatus control unit 203 determines that either one of the bookbinding-related setting and the interleaf insertion setting is not made (NO in steps S604 and S605), the processing proceeds to FIG. 6C, to execute the job.

FIG. 6C is a flowchart illustrating a method for controlling the printing apparatus according to the present exemplary embodiment. This example is an example of processing performed after the job is input. Each of steps is implemented when the CPU provided in the image forming apparatus control unit 203 loads a control program into a RAM from a ROM or another storage device and executes the control program. Interleaf insertion processing for inserting an interleaf between discharged sheets until a state of the printer unit 206 transits to a state where print processing can be resumed again and a sheet to be newly discharged using the inserter 406 will be described. In the present exemplary embodiment, an interleaf insertion mode for determining whether the interleaf is inserted using the inserter 406 is settable from the operation unit 207, and information relating to the setting is retained in a memory (a nonvolatile memory) that can be referenced by the image forming apparatus control unit 203.

If it is determined that the state of the printer unit 206 has shifted to the state where print processing can be resumed again, either one of first processing for starting to insert the interleaf by the inserter 406 after releasing a post-processing mode and second processing for starting to perform print processing based on the post-processing mode without inserting the interleaf by the inserter 406 is performed depending on the setting of the interleaf insertion mode. The first processing corresponds to steps S609 and S610. The second processing corresponds to processing from step S609 to step S611.

In step S608, the image forming apparatus control unit 203 determines whether recovery processing of a jam or the like has occurred in the image forming apparatus 101 from inputs of various sensors. If it is determined that the recovery processing has occurred (YES in step S608), the processing proceeds to step S609. In step S609, the image forming apparatus control unit 203 determines whether the interleaf insertion flag is set. If the image forming apparatus control unit 203 determines that the interleaf insertion flag is set (YES in step S609), the processing proceeds to step S610. In step S610, the image forming apparatus control unit 203 controls the finisher control unit 501, to feed interleaves from the inserter 406, and insert the one interleaf previously when the processing returns from recovery. In step S611, the image forming apparatus control unit 203 starts normal job output.

On the other hand, if the image forming apparatus control unit 203 determines that the interleaf insertion flag is not set (NO in step S609), the processing proceeds to step S611 after the recovery processing ends. In step S611, the image forming apparatus control unit 203 starts the normal job output. In step S612, the image forming apparatus control unit 203 determines whether all jobs are ended. Steps S608 to S612 are repeated until it is determined that all the jobs are ended.

As described above, in the present exemplary embodiment, a setting to insert an interleaf representing a position where recovery has been performed is made, and control is performed not to execute a job while a setting to perform bookbinding processing is made. Thus, post-processing, which is not intended by a user, is not performed for a sheet bundle including the interleaf representing the position where recovery has been performed.

While the bookbinding processing has been described as an example in the present exemplary embodiment, a job may be stopped without being executed if binding processing such as stapling processing and insertion of an interleaf representing a position where recovery has been performed are set.

In the first exemplary embodiment, an example in which a job is canceled after an instruction to execute the job is received since a setting for inserting an interleaf representing a position where recovery has been performed and a setting for performing bookbinding processing are made.

Reception of one of a setting for inserting an interleaf representing a position where recovery has been performed and a setting for performing bookbinding processing is permitted but reception of both the settings is limited according to a second exemplary embodiment. Description of a main configuration of a printing apparatus is similar to the first exemplary embodiment, and hence description thereof is not repeated.

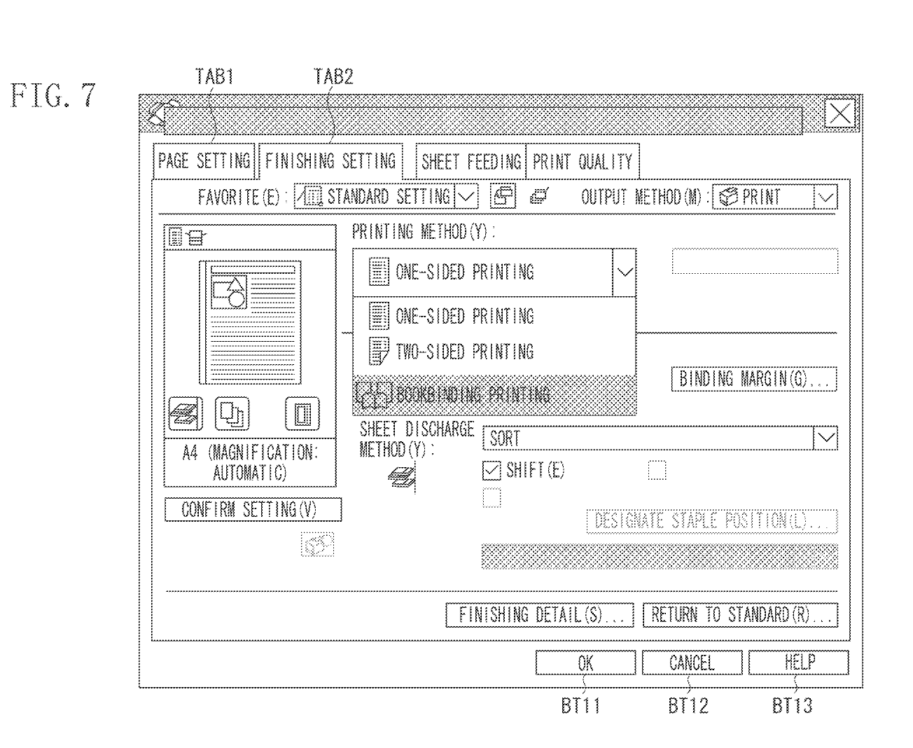

FIG. 7 illustrates an example of a user interface displayed on display devices in the client PCs 111 and 112 illustrated in FIG. 1. This example is an example of a warning screen on a finishing setting screen of a printer driver in the client PC. This example is an example of a warning screen displayed when a bookbinding-related setting is made while interleaf insertion processing is set. This screen is configured so that a print setting corresponding to a plurality of tab sheets can be made, and includes a TAB1 for a page setting and a TAB2 for a finishing setting. This example corresponds to a state where the TAB2 is currently selected. The finishing setting screen is displayed and bookbinding processing is gray-out displayed so that the bookbinding processing is not selectable by the processing illustrated in FIG. 6C. The reason for the gray-out display is displayed with a message. A user can fix the current setting, close the displayed screen, and call a help by pressing buttons BT11 to BT13 as an instruction.

While a bookbinding-related setting itself is inhibited by gray-out when an interleaf insertion setting is made in an example illustrated in FIG. 7, a warning may be given when the interleaf insertion setting is made after the bookbinding-related setting is made.

While a driver screen is displayed in client PC during printing in the present exemplary embodiment, the operation unit 207 in the image forming apparatus 101 displays a screen on which a bookbinding-related setting cannot be selected when the bookbinding-related setting is made during copying.

According to the present exemplary embodiment, when the interleaf insertion setting during recovery is made, ease of inspection in a recovery area by the user can be ensured. At the same time, unwitting bookbinding of the interleaf, which is not originally included in the job, can be prevented without great change of a configuration.

In a third exemplary embodiment, when the job is input in the first exemplary embodiment, a user is caused to select for each job whether execution of bookbinding processing or insertion of an interleaf at the time of recovery is given priority. A main configuration of the printing apparatus is similar to the first exemplary embodiment, and hence description thereof is not repeated.

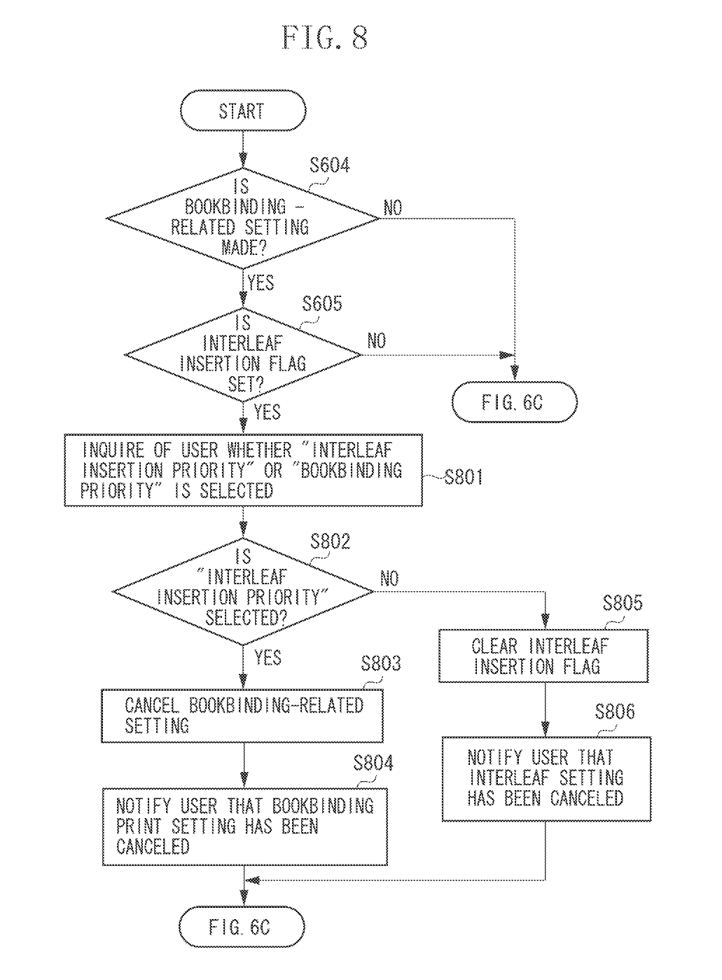

FIG. 8 is a flowchart illustrating a method for controlling the printing apparatus according to the present exemplary embodiment. This example is an example of processing performed when a job is input. Each of steps is implemented when a CPU provided in an image forming apparatus control unit 203 loads a control program into a RAM from a ROM or another storage device and executes the control program. The flowchart illustrated in FIG. 8 is performed instead of FIG. 6B in the first exemplary embodiment. The same steps as those illustrated in FIG. 6B are assigned the same step numbers, and hence description thereof is not repeated.

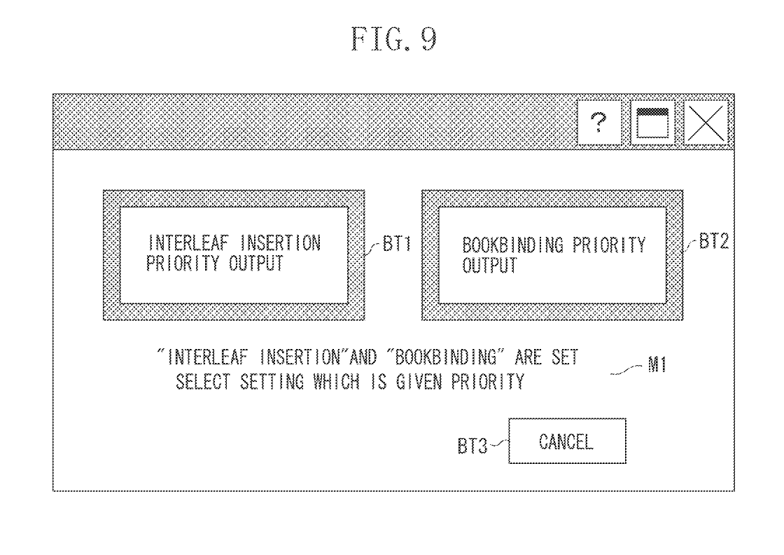

If the image forming apparatus control unit 203 determines that a bookbinding-related setting is made for a job (YES in step S604), and that an interleaf insertion flag is set (YES in step S605), the processing proceeds to step S801. In step S801, the image forming apparatus control unit 203 displays on an operation unit 207 a screen for inquiring of the user whether “interleaf insertion priority” or “bookbinding priority” is selected (one example is illustrated in FIG. 9).

FIG. 9 illustrates an example of a UI screen displayed on the operation unit 207 illustrated in FIG. 2. If it is determined that a state of a printer unit 206 has transited to a state where print processing can be resumed again (a state where recovery processing ends), a first instruction to give priority to first processing or a second instruction to give priority to second processing is received via the UI screen. A notification is made that a post-processing mode set by the user has been released via the UI screen if the first instruction is received and a notification is made that an interleaf insertion mode set by the user has been released via the UI screen if the second instruction is received, as described below.

FIG. 9 illustrates a screen on which the user can select one of buttons BT1 to BT3 in an inquiry message M1 used when one of “interleaf insertion priority” and “bookbinding priority” is selected. When the user presses the button BT1, the image forming apparatus control unit 203 determines that the user has selected “interleaf insertion priority”. When the user presses the button BT2, the image forming apparatus control unit 203 determines that the user has selected “bookbinding priority”. Further, when the screen displayed on the operation unit 207 is erased, the user presses the button BT3 so that the image forming apparatus control unit 203 performs control to erase the screen.

In step S802, the image forming apparatus control unit 203 determines whether the user selects “interleaf insertion priority” by pressing of the button BT1. If it is determined that the user has selected “interleaf insertion priority” (YES in step S802), the processing proceeds to step S803. In step S803, the image forming apparatus control unit 203 cancels a bookbinding-related setting, and the processing proceeds to step S804. In step S804, the image forming apparatus control unit 203 notifies the user that the bookbinding-related setting has been canceled. The image forming apparatus control unit 203 displays a message indicating that the bookbinding-related setting has been canceled on the operation unit 207 and the processing proceeds to FIG. 6C.

On the other hand, if the image forming apparatus control unit 203 determines that the user has selected “bookbinding priority” by pressing the button BT2 (NO in step S802), the processing proceeds to step S805. In step S805, the image forming apparatus control unit 203 clears the interleaf insertion flag retained in its memory. In step S806, the image forming apparatus control unit 203 notifies the user that the interleaf insertion setting has been canceled. The image forming apparatus control unit 203 displays a message indicating that the interleaf insertion setting has been canceled on the operation unit 207. The processing proceeds to FIG. 6C.

On the other hand, if it is determined that the user has pressed a cancel button on the screen illustrated in FIG. 9, the image forming apparatus control unit 203 cancels the job, and the processing ends.

According to the present exemplary embodiment, even if the interleaf insertion setting at the time of recovery is made, the bookbinding-related setting can be made non-uniform. A request to switch between “interleaf insertion priority” and “bookbinding priority” depending on the job is received from the user, and data processing can be switched according to the request.

More specifically, according to the present exemplary embodiment, the request from the user can be reflected more flexibly on each job while unwitting bookbinding of the interleaf, which is not originally included in the job, is prevented without a great change a configuration.

In the above-mentioned exemplary embodiment, it is confirmed whether an interleaf insertion is set at the time of input of a job even when an interleaf insertion is set at the time of recovery. In a fourth exemplary embodiment, it is not confirmed whether an interleaf insertion is set at the time of input of a job even when an interleaf insertion is set at the time of recovery. According to the present exemplary embodiment, it is determined whether post-processing is performed every time print processing in a predetermined unit ends even in the same job. More specifically, if multiple copies are printed, it is determined whether post-processing is performed depending on occurrence recovery processing within the same copy. A main configuration of a printing apparatus is similar to the first exemplary embodiment, and hence description thereof is not repeated.

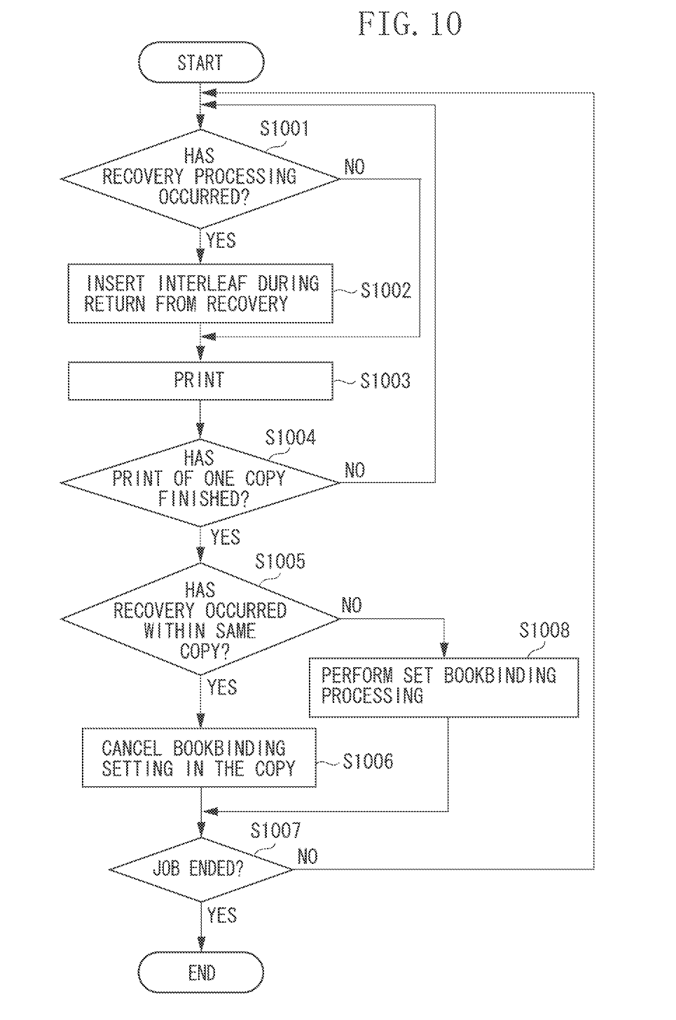

An image forming apparatus control unit 203 performs processing according to a flowchart illustrated in FIG. 10 as described below as an example. Every time print processing in a predetermined unit ends, first processing for canceling post-processing is performed by a finisher unit 102 on a first sheet bundle determined to have been subjected to processing for inserting an interleaf by an inserter 406. In addition, second processing for post-processing is performed by the finisher unit 102 on a second sheet bundle determined not to have been subjected to processing for inserting an interleaf as described in detail below.

FIG. 10 is a flowchart illustrating a method for controlling the printing apparatus according to the present exemplary embodiment. This example is an example in which output processing is performed for each sheet when recovery processing is necessary. Each of steps is implemented when a CPU provided in the image forming apparatus control unit 203 loads a control program into a RAM from a ROM or another storage device and executes the control program. The CPU performs processing in the flowchart illustrated in FIG. 10 when an operation unit 207 receives a print instruction.

In step S1001, the image forming apparatus control unit 203 checks an output of each of various sensors, to determine whether recovery processing is necessary.

If the image forming apparatus control unit 203 determines that the processing which needs recovery has occurred (YES in step S1001), the processing proceeds to step S1002. In step S1002, the image forming apparatus control unit 203 controls a finisher control unit 501, to perform processing for inserting an interleaf at the time of return from recovery. On the other hand, if the image forming apparatus control unit 203 determines that the processing which needs recovery has not occurred (NO in step S1001), the processing proceeds to step S1003.

In step S1003, the image forming apparatus control unit 203 prints one sheet according to information relating to a job.

In step S1004, the image forming apparatus control unit 203 determines whether print of the first copy has finished. Processes in steps S1001 to S1003 are repeatedly performed until the printing of the first copy finishes.

If the image forming apparatus control unit 203 determines that the print of the first copy has finished (YES in step S1004), the processing proceeds to step S1005. In step S1005, the image forming apparatus control unit 203 determines whether recovery has occurred or an interleaf has been inserted in the first copy.

If the image forming apparatus control unit 203 determines that the recovery (the insertion of the interleaf) has occurred (YES in step S1005), the processing proceeds to step S1006. In step S1006, only a bookbinding-related setting for the first copy is canceled, and the processing proceeds to step S1007.

On the other hand, if the image forming apparatus control unit 203 determines that the recovery has not occurred in the first copy (NO in step S1005), the processing proceeds to step S1008. In step S1008, the image forming apparatus control unit 203 performs set desirable bookbinding processing, and the processing proceeds to step S1007. In step S1007, the image forming apparatus control unit 203 determines whether the job is ended. If the job is a single copy, the processing ends. If the job is multiple copies, the processing returns to step S1001, and processes in steps S1001 to S1007 are repeatedly performed until the job is ended.

According to the present exemplary embodiment, even if the interleaf insertion setting during recovery is made, the bookbinding-related setting is not uniformly inhibited. The bookbinding-related setting is canceled only for a copy in which recovery has occurred so that an interleaf has been inserted. On the other hand, the desired bookbinding-related setting is automatically selectable for a copy (a printing bundle) in which recovery has not occurred.

More specifically, according to the present exemplary embodiment, control in units of copies in the job can be more flexibly performed, and ease of inspection in a recovery area by the user can be ensured. In addition, careless bookbinding of the interleaf, which is not originally included in the job, can be prevented.

### Another Embodiment

While bookbinding processing is described as post-processing as an example in the first to fourth exemplary embodiments, the present invention is not limited to this. Stapling processing may be post-processing. More specifically, the description of the first to fourth exemplary embodiments and the processing in the flowcharts may be applied to a setting for performing stapling processing and a setting for inserting an interleaf representing a position where recovery has been performed.

While a conveyance jam of a sheet is taken as an example of a recovery factor in the above-mentioned exemplary embodiments, errors in a post-processing apparatus and an interleaf insertion apparatus can also be included in the recovery factor. Therefore, running out of a staple, for example, may be the recovery factor.

Further, when the number of sheets to be stacked is limited, a factor for executing print processing and stopping the print processing before discharge of the sheets have been finished can also be included in the present invention.

### Other Embodiments

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium). In an example, a computer-readable storage medium may store a program that causes a printing apparatus to perform a method described herein. In another example, a central processing unit (CPU) may be configured to control at least one unit utilized in a method or apparatus described herein.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-093274 filed Apr. 19, 2011, which is hereby incorporated by reference herein in its entirety.

What is claimed is:

1. A printing apparatus comprising:
a post-processing control unit configured to perform control to perform binding processing for binding a print product;
an adding control unit configured to perform control to add, to the print product, a sheet representing an area where printing has been interrupted due to occurrence of an interruption factor; and
a control unit configured to perform control not to perform the binding processing for the print product to which the sheet has been added by the adding control unit.

2. The printing apparatus according to claim 1, further comprising:
a first receiving unit configured to receive a setting for performing the binding processing; and
a second receiving unit configured to receive a setting for adding the sheet,
wherein the control unit limits reception of both the setting for performing the binding processing by the first receiving unit and the setting for adding the sheet by the second receiving unit.

3. The printing apparatus according to claim 1, further comprising:
a first receiving unit configured to receive a setting for performing the binding processing;
a second receiving unit configured to receive a setting for adding the sheet, and
a notification unit configured to notify an error message in response to the first receiving unit receiving a setting for performing the binding processing and the second receiving unit receiving the setting for adding the sheet.

4. The printing apparatus according to claim 1, further comprising:
a first receiving unit configured to receive a setting for performing the binding processing;
a second receiving unit configured to receive a setting for adding the sheet; and
a third receiving unit configured to receive from a user selection whether the binding processing is performed or the sheet is added when it has received an instruction to start printing while the first receiving unit has received the setting for performing the binding processing and the second receiving unit has received the setting for adding the sheet,
wherein the control unit performs control to perform the binding processing without adding the sheet in response to the third receiving unit receiving the selection for performing the binding processing, and performs control to add the sheet without performing the binding processing in response to the third receiving unit receiving the selection for adding the sheet.

5. The printing apparatus according to claim 1, wherein the binding processing is stapling processing or bookbinding processing.

6. The printing apparatus according to claim 1, wherein the addition of the sheet by the adding control unit is insertion of the sheet.

7. A control method for controlling a printing apparatus, the control method comprising:
performing control to perform binding processing for binding a print product;
performing control to add, to the print product, a sheet representing an area where printing has been interrupted due to occurrence of an interruption factor; and
performing control not to perform the binding processing for the print product to which the sheet has been added.

8. A non-transitory computer readable storage medium storing a program that causes a printing apparatus to perform the control method according to claim 7.
